(19) United States
(12) Patent Application Publication
(10) Pub. No.: US 2009/0252261 A1
(43) Pub. Date: Oct. 8, 2009

(54) System, Apparatus, and Method for Processing a Received Orthogonal Frequency Division Multiplexing Signal

(75) Inventors: Wen-Rong Wu, Hsin-Chu City (TW); Hung-Tao Hsieh, Chu-Pei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsinchu (TW)

(21) Appl. No.: 12/061,177

(22) Filed: Apr. 2, 2008

(51) Int. Cl. H04L 27/06

(52) U.S. Cl. 375/343

(57) ABSTRACT

A wireless communication system, an apparatus and a method for processing a received OFDM signal is provided. The wireless communication system comprises an interface and a processing apparatus. The interface is configured to receive a received OFDM signal. The processing apparatus comprises an estimation module and a calculation module. The estimation module is configured to estimate an auto-correlation matrix relating to the received OFDM signal, with the auto-correlation matrix comprising a plurality of elements. Then, the calculation module is configured to calculate an amplitude and a phase for each of the elements to determine the carrier frequency offset (CFO) and timing offset (TO) of the received OFDM signal according to the amplitudes and phases. By exploiting the auto-correlation matrix of the received OFDM signal, the CFO and TO can be derived efficiently.

### CROSS-REFERENCES TO RELATED APPLICATIONS

Not applicable.

### BACKGROUND OF THE INVENTION

1. Field of the Invention

The present invention relates to a system, an apparatus, and a method for processing a received OFDM signal; specifically, the invention relates to a system, an apparatus, and a method for processing a received OFDM signal for a carrier frequency offset and a timing offset.

2. Descriptions of the Related Art

Orthogonal frequency division multiplexing (OFDM) is a kind of transmission technology that has been commonly used in wireless communications. An OFDM system is known to be sensitive to the carrier frequency offset (CFO). CFO is usually induced by the mismatch of the oscillations between the transmitter and the receiver of the OFDM system and/or the Doppler effect. An OFDM system is also sensitive to the timing offset (TO), which is usually induced by channel delays.

There are several approaches for estimating the CFO, such as using the maximum likelihood (ML) method, analytic tone, and minimum variance unbiased (MVU) estimator. The conventional ML method requires root-solving during the estimation of the CFO, which is computationally complex. FIG. 1 schematically illustrates a wireless communication system 1 that adopts the conventional ML method. The wireless communication system 1 comprises a transmitter 11 and a receiver 12 that communicate with each other through a multipath channel 13. The transmitter 11 comprises an OFDM-based modulator 111 and a transmitting interface 112. The receiver 12 comprises a receiving interface 123 and an OFDM-based ML CFO estimator 125.

The original signal generated by the OFDM-based modulator 111 is denoted as s(k). The original signal, denoted as s(k), comprises Q repeated preambles, while each of the preambles comprises N samples. The repeated preambles allow for the original signal to have the following property: s(n)=s(n+qN), wherein q=0, . . . , Q−1 and n=0, . . . , N−1. Then, the transmitting interface 112 transmits the original signal, s(k), through the multipath channel 13, wherein the multipath channel 13 has a frequency response, h(k).

The receiving interface 123 receives the signal transmitted by the transmitter 11 as a received signal 124, denoted as y(k), wherein

$$y ( k ) = {e}^{j 2 πɛ \frac{k}{N}} h ( k ) * s ( k ) + w ( k ) .$$

The term x(k)=h(k)*s(k) represents the original signal s(k) being transmitted through the multi-path channel 13. The term ε represents CFO, so the term

$${e}^{j2 πɛ \frac{k}{N}}$$

indicates the effect cased by the CFO. The term w(k) is used to represent an additive white Gaussian noise (AWGN) introduced during the transmission because the multi-path channel 13 is not a perfect channel. The OFDM-based ML CFO estimator 125 estimates the CFO ε by processing the received signal 124. In other words, the OFDM-based ML CFO estimator 125 will find the root of ε.

Since channel delay is smaller than one received preamble, the receiver 12 drops the first received preamble (q=0) so that the periodic property is maintained. Thus, the number of dealt preambles is K=Q−1. FIG. 2 is a schematic diagram of the signal model, i.e. the K preambles, wherein the preamble 21 represents the first preamble (q=1), the preamble 22 represents the second preamble (q=2), and so on. The preamble 21 comprises N samples, for example, sample 210 is y(0+N), sample 211 is y(1+N), and so on. Similarly, the preamble 22 comprises N samples; for example, sample 220 is y(0+2N), sample 221 is y(1+2N), and so on. In FIG. 2, the preambles 21, 22 are aligned according to the index in the parentheses. For example, sample 210 and 220 appear in the same column.

Then, the K samples of the same column are collected to form a vector. To be more specific, sample 210 of the preamble 21, sample 220 of the preamble 22, and so on form the vector y(0). The following vectors are derived:

$$y ( n ) = {[ y ( N + n ) , … , y ( KN + n ) ]}^{T} , \\ x ( n ) = {{e}^{j 2 πɛ \frac{k}{N}} [ x ( N + n ) , … , x ( KN + n ) ]}^{T} , \\ and$$

$$w ( n ) = {[ w ( N + n ) , … , w ( KN + n ) ]}^{T} , \\ wherein n = 0 , … , N - 1.$$

The relationship between the vectors y(n), x(n), and w(n) can be represented as Y=AX+W, wherein

$$Y = {[ y ( 0 ) , … , y ( N - 1 ) ]}_{( K \times N )}$$

$$A = diag {\{ [ {e}^{j2πɛ} , … , {e}^{j 2 π ɛ K} ] \}}_{( K \times K )}$$

$$X = {[ x ( 0 ) , … , x ( N - 1 ) ]}_{( K \times N )} , \\ and$$

$$W = {[ w ( 0 ) , … , w ( N - 1 ) ]}_{( K \times N )} .$$

The likelihood function used to find the CFO can be expressed as

$$Λ = {A}^{H} {R}_{y} A = {\sum }_{m = - ( K - 1 )}^{K - 1} b ( m ) \cdot {z}^{m} ,$$

wherein

$${R}_{y} ≡ E \{ {YY}^{H} \} , \\ {R}_{p , q} ≡ {[ {R}_{y} ]}_{p , q} = \frac{1}{N} {\sum }_{n = 0}^{N - 1} y ( pN + n ) {y}^{*} ( qN + n ) , \{ p , q \vert 1 , … K \} , \\ z ≡ {e}^{j 2 π ɛ} , and$$

$$b ( m ) ≡ b ( q - p ) = {\sum }_{p , q} {R}_{p , q} .$$

As mentioned, ε represents CFO. Consequently, the task is to derive the value of ε. To be more specific, the conventional ML method calculates ε by letting:

$$\frac{\partial }{\partial ɛ} Λ ( z ) = \frac{\partial z}{\partial ɛ} \frac{\partial }{\partial z} Λ ( z ) = 0.$$

The set of the roots to the above equation is Ω={z|Λ(z)=0,|z|=1} The desired estimate to the above equation is

$$\hat{ɛ} = \frac{1}{j 2 π} ln ( \hat{z} ) ,$$

wherein \hat{z} denotes the root that maximizes the likelihood function. However, this approach requires a root-finding process. Since the degree of Λ is 2K−1, the computationally complexity is extremely high.

The second type of approach for estimating the CFO is using the analytic tone. U.S. Pat. No. 7,012,881 presents a time and frequency offset estimation scheme for OFDM systems using an analytic tone. The analytic tone includes a signal that contains only one sub-carrier, a uniform magnitude rotation and a uniform phase rotation. The estimation algorithm using the analytic tone is based on an auto-correlation function. By changing the interval between two samples in an auto-correlation, the maximum estimation range for the frequency offset can be extended to N/2 sub-carrier spacing, wherein N is the total number of sub-carriers. However, the analytic tone approach requires aided data and limited CFO estimation range.

The third type of approach for estimating the CFO is to use a minimum variance unbiased (MVU) estimator, such as the one presented in U.S. Pat. No. 7,027,543. The use of sufficient statistics provides a minimum variance unbiased (MVU) to estimate the frequency offset under the complete knowledge of a time offset error and estimation of a carrier offset under uncertain symbol timing errors. Unlike the analytic tone approach, the MVU estimator approach does not rely on any probabilistic assumptions and does not require aided data. However, its performance is worse than the maximum likelihood estimator.

According to the aforementioned descriptions, a more efficient method to solve CFO and TO without finding a root for a maximum likelihood function is still a critical issue in this field.

### SUMMARY OF THE INVENTION

An objective of the present invention is to provide a wireless receiving system. The wireless communication system comprises an interface and a processing apparatus. The interface is configured to receive a received OFDM signal. The processing apparatus is configured to process the received OFDM signal. The processing apparatus comprises an estimation module and a calculation module. The estimation module is configured to estimate an auto-correlation matrix relating to the received OFDM signal, with the auto-correlation matrix comprising a plurality of elements. The calculation module is configured to calculate an amplitude and a phase for each of the elements and calculating a carrier frequency offset (CFO) of the received OFDM signal according to the amplitudes and the phases.

Another objective of the present invention is to provide an apparatus for processing a received OFDM signal. The apparatus comprises an estimation module and a calculation module. The estimation module is configured to estimate an auto-correlation matrix relating to the received OFDM signal, with the auto-correlation matrix comprising a plurality of elements. The calculation module is configured to calculate an amplitude and a phase for each of the elements and calculating a CFO of the received OFDM signal according to the amplitudes and the phases.

A further objective of the present invention is to provide a method for processing a received OFDM signal. The method comprises the following steps: estimating an auto-correlation matrix relating to the received OFDM signal, with the auto-correlation matrix comprising a plurality of elements; calculating an amplitude and a phase for each of the elements; and calculating a CFO of the received OFDM signal according to the amplitudes and the phases.

The aforementioned arrangements and steps may be executed repeatedly on different samples of the received OFDM signal to derive a plurality of CFOs. A selected CFO and a selected TO can be decided according to the CFOs. The present invention exploits a structure of an auto-correlation matrix relating to the received OFDM signal. Thus, CFO and TO can be calculated in a more efficient approach.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 schematically illustrates a conventional wireless communication system;

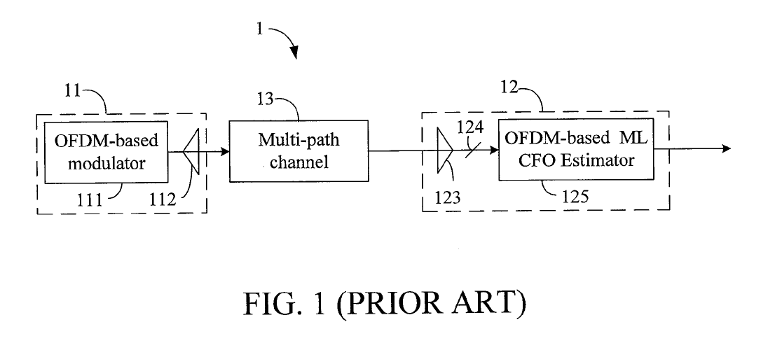

FIG. 2 illustrates a schematic diagram of the signal model;

FIG. 3 illustrates a first embodiment of the present invention;

FIG. 4 illustrates a simulation result using the conventional methods and the present invention;

FIG. 5 illustrates another simulation result using the conventional methods and the present invention;

FIG. 6 illustrates a second embodiment of the present invention;

FIG. 7 illustrates the simulation result using the conventional methods and the second embodiment; and

FIG. 8 illustrates a third embodiment of the present invention.

### DESCRIPTION OF THE PREFERRED EMBODIMENT

The objective of the present invention is to provide a wireless receiving system, an apparatus, and a method to estimate a carrier frequency offset (CFO) and/or a timing offset (TO) of a received OFDM signal by an efficient maximum likelihood (ML) method. To be more specific, a structure of an auto-correlation matrix of the received OFDM signal is exploited to estimate the CFO and/or the TO. The present invention comprises three main parts: estimating the auto-correlation matrix relating to the received OFDM signal, calculating the amplitudes and phases of the elements in the auto-correlation matrix, and calculating the CFO and/or TO.

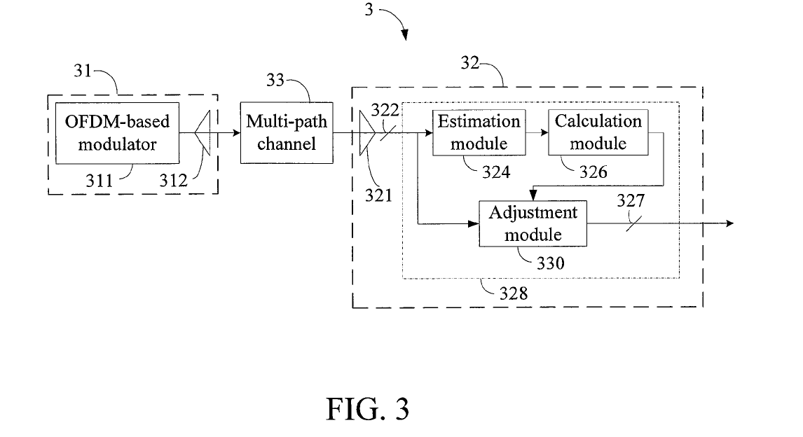

FIG. 3 illustrates a first embodiment of the present invention, which is a wireless communication system 3 adapted to the OFDM system. The wireless communication system 3 comprises a wireless transmitting system 31 and a wireless receiving system 32 in accordance with the present invention, wherein the wireless transmitting system 31 and the wireless receiving system 32 communicates with each other through a multi-path channel 33. The wireless transmitting system 31 comprises an OFDM-based modulator 311 and a transmitting interface 312. The wireless receiving system 32 comprises a receiving interface 321 and a processing apparatus 328. The processing apparatus 328 comprises an estimation module 324, a calculation module 326, and an adjustment module 330. The OFDM-based modulator 311 and transmitting interface 312 are the same as those comprised in the conventional transmitter 11, while the receiving interface 321 is the same as that comprised in the conventional receiver 12.

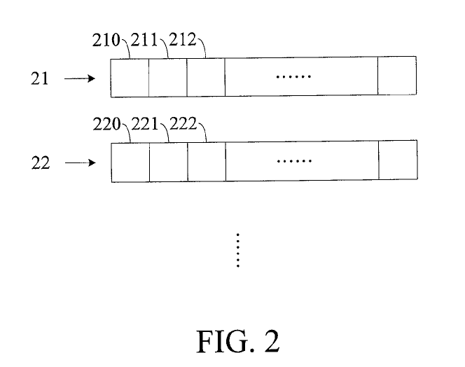

The signal model used in the present invention is similar to the one used in the conventional ML method. That is, an original signal, s(k), generated by the wireless transmitting system 31 comprises Q repeated preambles, with each of the preambles comprising N samples as shown in FIG. 2. Again, the original signal, s(k), that comprises the repeated preambles has the property, i.e. s(n)=s(n+qN), wherein q=0, . . . , Q−1 and n=0, . . . , N−1.

As in the conventional ML method, the first preamble (q=0) is also discarded to remain the periodic property and the receiving interface 321 receives the original signal as a received OFDM signal 322, denoted as y(k). The received OFDM signal 322 comprises a plurality of samples corresponding to the aforementioned preambles.

Now, the processing apparatus 328 processes the received OFDM signal 322, y(k), to derive the CFO. As mentioned, in order to derive the CFO, an auto-correlation matrix relating to the received OFDM signal 322 and the amplitudes and phases of the elements in the audio-correlation matrix have to be calculated first. The reason is explained here.

As in the conventional ML method, the received OFDM signal 322, y(k), can be represented as

$$y ( k ) = {e}^{j 2 πɛ \frac{k}{N}} h ( k ) * s ( k ) + w ( k ) ,$$

wherein x(k)=h(k)*s(k) and ε represents the CFO. The processing apparatus 328 also combines x(n), y(n), and w(n) into vectors:

$$y ( n ) = {[ y ( N + n ) , … , y ( KN + n ) ]}^{T} , \\ x ( n ) = {{e}^{j 2 πɛ \frac{k}{N}} [ x ( N + n ) , … , x ( KN + n ) ]}^{T} , \\ and$$

$$w ( n ) = {[ w ( N + n ) , … , w ( KN + n ) ]}^{T} , \\ wherein n = 0 , … , N - 1.$$

Now, the received OFDM signal 322, y(n), can also be formulated:
y(n)=u(n)+w(n), wherein

$$u ( n ) = {{e}^{j 2 ɛ \frac{n}{N}} [ x ( N + n ) , … , x ( KN + n ) ]}^{T} .$$

The auto-correlation matrix of y(n) is denoted as R_{y}, which comprises a plurality of elements γ_{p,q}=E{y(pN+n)y*(qN+n)} wherein p,q=1, . . . , K. The auto-correlation matrix R_{y} can be expressed as:

$${R}_{y} = E \{ y ( n ) {y}^{H} ( n ) \} = {R}_{u} + {σ}_{w}^{2} I , wherein$$

$${R}_{u} = E \{ u ( n ) {u}^{H} ( n ) \} = {σ}_{x}^{2} [ \begin{matrix}1 & z & ⋯ & {z}^{K - 1} \\ {z}^{*} & 1 & ⋯ & {z}^{K - 2} \\ ⋮ & ⋮ & ⋰ & ⋮ \\ {( {z}^{K - 1} )}^{*} & {( {z}^{K - 2} )}^{*} & ⋯ & 1\end{matrix} ] , \\ z = {e}^{j \frac{2 πɛ}{N}} .$$

The auto-correlation of the samples relating to the preambles is expressed by the following equation:

$$E \{ y ( pN + n ) {y}^{*} ( qN + n ) \} = \{ \begin{matrix}{σ}_{x}^{2} + {σ}_{w}^{2} , & p = q \\ {σ}_{x}^{2} {e}^{- j 2 π ( q - p )} , & p \neq q\end{matrix} ,$$

wherein {p,q}ε{1, . . . , K}, nε={0, . . . , N−1}, σₓ² is the variance of x(n), and σₓ² is the variance of AWGN. There is no angle when p=q, while there is an angle when p≠q. Consequently, the likelihood function can be expressed as:

$$Λ ( ɛ ) = ln \{ {\prod }_{n ∈ [ 0 , N - 1 ]} \frac{f [ y ( N + n ) , … , y ( KN + n ) ]}{f [ y ( N + n ) … y ( KN + n ) ]} \} {\prod }_{\begin{matrix}m ∈ [ 1 , K ] \\ n ∈ [ 0 , N - 1 ]\end{matrix}} f [ y ( mN + n ) ] ,$$

wherein

$$\frac{f [ y ( N + n ) , … , y ( KN + n ) ]}{f [ y ( N + n ) … y ( KN + n ) ]}$$

is the K dimension Gaussian probability density function, each of the f[y(N+n)], . . . , f[y(KN+n)] is an 1-D Gaussian probability density function and can be denoted as

$$\frac{exp ( - \frac{{\vert y ( pN + n ) \vert}^{2}}{{σ}_{x}^{2} + {σ}_{w}^{2}} )}{π ( {σ}_{x}^{2} + {σ}_{w}^{2} )} ,$$

and

$${\prod }_{\begin{matrix}m ∈ [ 1 , K ] \\ n ∈ [ 0 , N - 1 ]\end{matrix}} f [ y ( mN + n ) ]$$

is independent of the CFO. In addition,

f[y(N+n), . . . , y(KN+n)]=π^{-K}[det(R_{y})]⁻¹exp(−Y^{H}R_{y}⁻¹Y)

wherein

$${R}_{y}^{- 1} = {σ}_{w}^{- 2} I - \frac{{σ}_{x}^{2}}{{σ}_{w}^{4} + K {σ}_{w}^{2} {σ}_{x}^{2}} α , \\ and$$

$$α = [ \begin{matrix}1 & {e}^{j 2 π ɛ} & ⋯ & {e}^{j 2 π ( K - 1 ) ɛ} \\ {e}^{- j 2 πɛ} & 1 & ⋯ & {e}^{j2 π ( K - 2 ) ɛ} \\ ⋮ & ⋮ & ⋰ & ⋮ \\ {e}^{- j 2 π ( K - 1 ) ɛ} & {e}^{- j 2 π ( K - 2 ) ɛ} & ⋯ & 1\end{matrix} ] .$$

By substituting these probability density functions, the likelihood function of the present invention can be expressed as:

$$Λ ( ɛ ) = {c}_{1} + {c}_{2} φ + {c}_{3} {\sum }_{p = 1}^{K} {\sum }_{p > q}^{K} \vert {γ}_{p , q} \vert cos ( {ψ}_{p , q} ) , \qquad ( 1 )$$

wherein c₁, c₂, and c₃ are constants, and

$$φ = \frac{1}{2} {\sum }_{p} {\sum }_{n} {\vert y ( pN + n ) \vert}^{2}$$

is the received power,

$${γ}_{p , q} = {\sum }_{n = 0}^{N - 1} y ( pN + n ) {y}^{*} ( qN + n ) , and {ψ}_{p , q} = 2 πɛ ( q - p ) + {∠γ}_{p , q} .$$

In order to derive CFO, the likelihood function (1) is derived by setting the following equation to zero:

$$\frac{\partial }{\partial ɛ} Λ ( ɛ ) = {\sum }_{p = 1}^{K} {\sum }_{q > p}^{K} 2 π ( p - q ) \vert {γ}_{p , q} \vert sin ( {ψ}_{p , q} ) = 0.$$

If the transmission channel has a high signal to noise ratio (SNR), ψ_{p,q} is small. Then, sin(ψ_{p,q})=ψ_{p,q}. Thus, the following CFO is derived:

$$\hat{ɛ} = - \frac{{\sum }_{p = 1}^{K} {\sum }_{q > p}^{K} \vert {γ}_{p , q} \vert ( q - p ) {∠γ}_{p , q}}{2 π {\sum }_{p = 1}^{K} {\sum }_{q > p}^{K} \vert {γ}_{p , q} \vert {( q - p )}^{2}} . \qquad ( 2 )$$

The present invention uses equation (2) to calculate CFO. Now, how the wireless receiving system 32 calculates CFO is described. Firstly, the estimation module 324 estimates the auto-correlation matrix R_{y} of the received OFDM signal 322. By doing so, the elements γ_{p,q} of R_{y} are derived. Then, the calculation module 326 calculates the amplitude and the phase for each of the elements γ_{p,q} in R_{y}. That is, the calculation module 326 calculates |γ_{p,q}| and ∠_{p,q}.

After deriving |γ_{p,q}| and ∠_{p,q}, the calculation module 326 calculates the CFO of the received OFDM signal y(n) according to the amplitudes and the phases. That is, the calculation module 326 substitutes the values of the amplitudes and phases into the above equation (2). After calculating the CFO, the adjustment module 330 can adjust the received OFDM signal 322 according to the CFO. Further, the adjustment module 330 can also adjust signals received in the future by the CFO.

Consequently, the calculation module 326 derives \hat{ε} as the CFO. By using the aforementioned arrangements and steps, the wireless receiving system 32 can find the CFO in a more efficient way.

TABLE 1
shows the complexity of the present invention and the conventional maximum
likelihood methods.

| | | | | 1^{st} embodiment | 2^{nd} embodiment |
|---|---|---|---|---|---|
| | | | | of the present | of the present |
| | Algorithm A | Algorithm A′ | Algorithm B | invention | invention |
| No. of multipli- cations | 2NK² + 7K − 10 | 2N(5K − 6) + 11 | 2K(NK + 3) − 6 | $( 2 NK + \frac{K}{2} + 3 ) ( K - 1 ) - 2$ | $NQ ( 2 N + \frac{7}{2} Q + \frac{1}{2} ) - 4$ |
| No. of additions | K(2NK + 3) − 5 | 2N(5K − 6) + 4 | 2NK² + 2K − 3 | $\begin{matrix}K ( K - 1 ) ( 2 N + \frac{K}{6} - \frac{1}{3} ) + \\ K - 5\end{matrix}$ | $\begin{matrix}QN ( 2 N + \frac{{Q}^{2}}{6} + 4 Q - 6 ) - \\ ( {Q}^{2} - Q + 8 ) + 5 N \end{matrix}$ |
| No. of ln{•} | 1 | 1 | 1 | 0 | 0 |
| No. of abs{•} | 0 | 0 | 0 | $\frac{K ( K - 1 )}{2}$ | $\frac{NQ ( Q - 1 )}{2}$ |
| No. of phases | 0 | 0 | 0 | $\frac{K ( K - 1 )}{2}$ | $\frac{NQ ( Q - 1 )}{2}$ |
| No. of | 1 | 1 | 2 | 1 | N |
| divisions | | | | | |

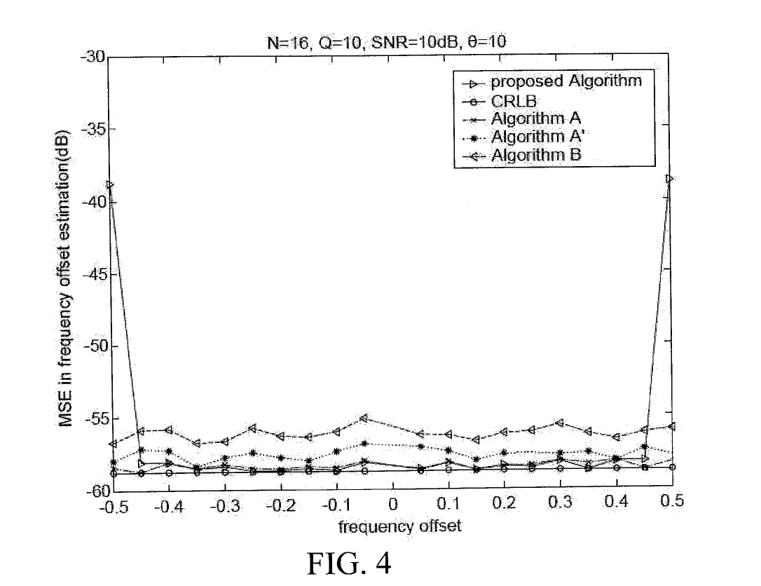

FIG. 4 illustrates a simulation result using the conventional ML methods (algorithms A, A′, and B) and the first embodiment. More particularly, algorithms A, A′, and B are conventional maximum likelihood methods and are detailed in the paper “Pilot-assisted maximum-likelihood frequency-offset estimation for OFDM systems,” IEEE Transactions on Communications, Vol. 52, No. 11, November 2004 by Jiun H. Yu and Yu T. Su.

The simulation environment was as follows: SNR=10 dB, N=16, and Q=10. In FIG. 4, the horizontal axis represents the frequency offset, while the vertical axis represents the mean-square-error (MSE) of the frequency offset estimation in dB. The solid curve with circles represents the Cramer-Rao lower bound (CRLB), which is calculated according to the following equation:

$$CRLB ≡ \frac{1}{- E [ \frac{{\partial }^{2}}{\partial {ɛ}^{2}} ] Λ ( \hat{ɛ} )} = \frac{1 + K \cdot SNR}{8 {π}^{2} N \cdot {SNR}^{2}} \frac{1}{{\sum }_{p = 1}^{K} {\sum }_{q > p}^{K} {( q - p )}^{2}} .$$

The simulation result shows that the present invention has smaller MSE values most of the time. The conventional methods have better performance when the CFO is large. The reason is that if the result of the estimation is with the opposite sign, it is still able to be adjusted. For example, when ε=0.5 and the estimated result is \hat{ε}=0.5 e^{j2πε}=e^{-j2π\hat{ε}}=e^{j2πn}, n=0, 1, 2, etc., which is able to compensate the CFO.

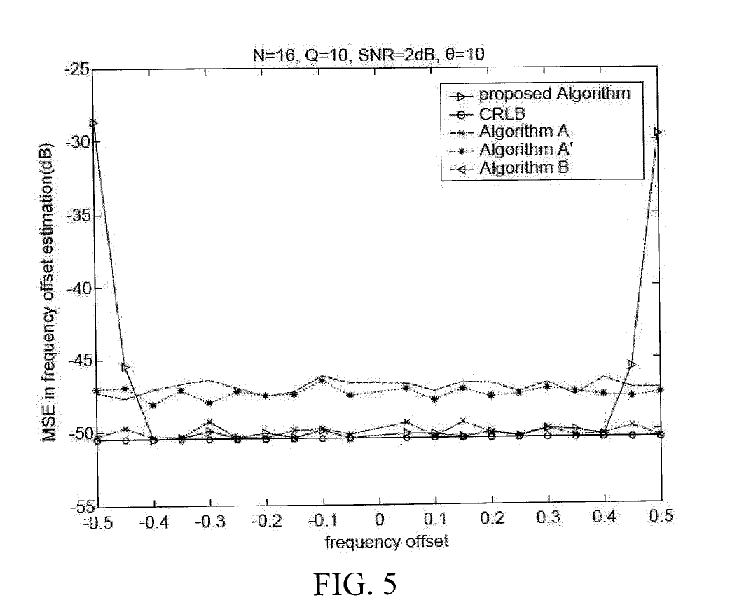

FIG. 5 illustrates another simulation result of the conventional methods (algorithms A, A′, and B) and the first embodiment. The simulation environment is as follows: SNR=2 dB, N=16, and Q=10. In FIG. 5, the horizontal axis represents the frequency offset, while the vertical axis represents the mean-square-error (MSE) of the frequency offset estimation in dB. Similarly, the simulation result shows that the present invention has smaller MSE values most of the time. Furthermore, when the frequency offset is large, the MSE values of the present invention are even smaller. However, the conventional methods have better performance when the CFO is large. The reason is the same as the aforementioned description.

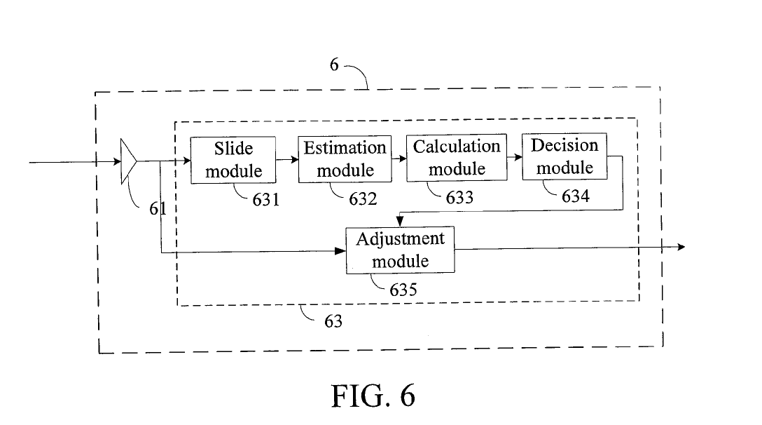

FIG. 6 illustrates another embodiment of the present invention, which is a wireless receiving system 6 adopting the ML method. The wireless receiving system 6 comprises a receiving interface 61 and an apparatus 63. The apparatus 63 comprises a slide module 631, an estimation module 632, a calculation module 633, a decision module 634, and an adjustment module 635. The wireless receiving system 6 is able to receive a signal generated by the transmitter 31 in the first embodiment, resulting in a received signal. The signal model in the second embodiment is the same as that in the first embodiment. However, instead of discarding the first period (q=0) as shown in the first embodiment, the second embodiment has Q repeated sequence.

The slide module 631 defines a sliding window with a second predetermined length. Assume that the second predetermined length is equal to QN in this embodiment, wherein Q is the number of preambles and N is the number of samples in each of the preambles. It is noted that the length of the sliding window is not limited to QN. It can be adjusted according to the particular situation. The slide module 631 slides the sliding window for a first predetermined length. Again, the first predetermined length slid by the sliding window can be adjusted according to that particular situation. To be more specific, the symbols in the sliding window are represented as:

Vⁱ={y(i), . . . , y(i+QN−1)},0≦i<N

wherein i indicates the first predetermined length slide by the slide module 631, i.e. i indicates the timing offset (TO). The sliding window with the correct timing can collect all the Q preambles.

Then, the estimation module 632 and the calculation module 633 perform the same operations as those described in the first embodiment. Consequently, the details are not repeated again. The slide module 631 continuously slides the sliding window so that the estimation module 632 and the calculation module 633 can repeat the estimations and calculations on different samples and thereby derive a plurality of CFOs and a plurality of TO.

More specifically, for each i, the ML function for Vⁱ can be expressed by the following equation:

$${Λ}^{i} ( ɛ ) ∝ {\sum }_{p = 1}^{Q} {\sum }_{q > p}^{Q} {\vert {γ}_{p , q}^{i} \vert}^{2} cos ( {ψ}_{p , q}^{i} ) .$$

Thus, the estimation module 632 estimates:

γ_{p,q}ⁱ,i=0, 1, . . . , N−1;p=1, 2, . . . , Q−1;q=p+1, . . . , Q.

Then, the calculation module 633 calculates the amplitudes and phases of γ_{p,q}ⁱ. After deriving the amplitudes and phases, the calculation module 633 calculates {\hat{ε}ⁱ,Λⁱ(\hat{ε}ⁱ)} for all i.

After deriving {\hat{ε}ⁱ,Λⁱ(\hat{ε}ⁱ}, the decision module 634 decides the iₒₚₜ such that

Λⁱ^{ₒₚₜ}(\hat{ε}ⁱ^{ₒₚₜ})≧Λⁱ(\hat{ε}ⁱ),iₒₚₜ≠i.

In other words, the decision module 634 decides the iₒₚₜ as a selected TO and the \hat{ε}ⁱ^{ₒₚₜ} as a selected CFO.

Since the wireless receiving system 6 of the second embodiment calculates the CFO according to the samples in various time intervals, it can find the TO. After the decision, the adjustment module 635 adjusts signals relating to the received OFDM signal according to the selected CFO and TO. In addition to the aforementioned operations and steps, the second embodiment is able to perform all the operations and functions described in the first embodiment.

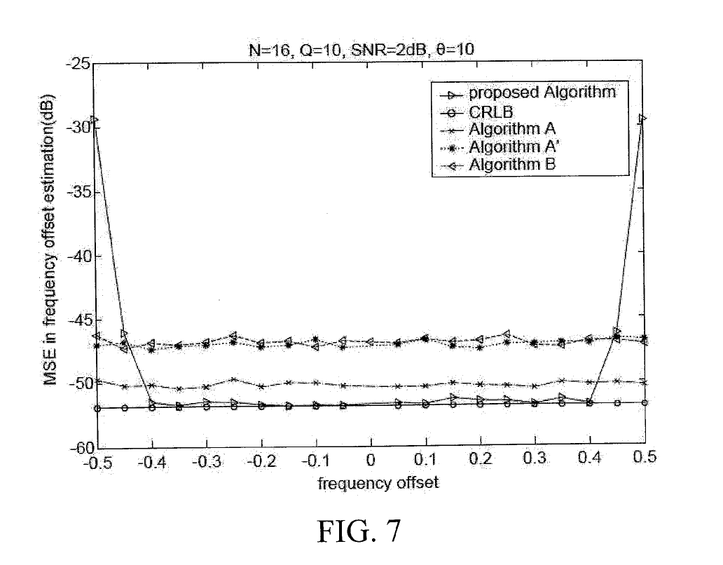

FIG. 7 illustrates the simulation result using the conventional methods and the second embodiment. The simulation environment is as follows: SNR=2 dB, N=16 and Q=10. The horizontal axis represents the frequency offset, while the vertical axis represents the MSE of the frequency offset estimation in dB. The simulation result shows that the present invention has smaller MSE values most of the time. However, the conventional methods have better performance when the CFO is large. The reason is the same as the aforementioned description.

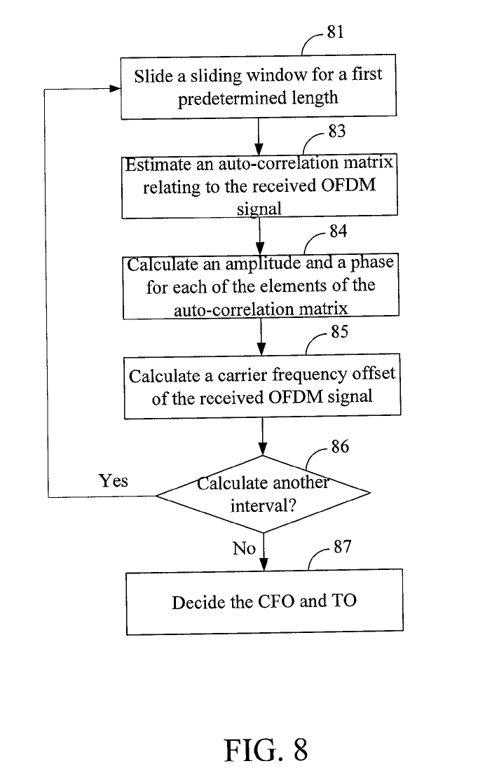

FIG. 8 illustrates a third embodiment of the present invention, which is a method for processing the received OFDM signal. First, step 81 is executed to slide a sliding window for a first predetermined length, wherein the sliding window is of a second predetermined length. Then, step 83 is executed to estimate an auto-correlation matrix relating to the received OFDM signal, wherein the auto-correlation matrix comprises a plurality of elements. Then, step 84 is executed to calculate the amplitude and phase for each of the elements. Step 85 is then executed to calculate a CFO according to the amplitudes and phases. Then, step 86 is executed to determine whether to calculate another interval. If so, the method proceeds to step 81. If not, then step 87 picks one of the CFOs as the selected CFO to determine the corresponding second predetermined length as the selected TO.

In addition to the above steps, the third embodiment is able to execute all the functions and operations described in the first and the second embodiments.

The main idea behind the present invention is to exploit the special structure of the auto-correlation matrix. Consequently, the present invention does not have to solve roots, thereby, reducing the complexity. According to the simulation results, the estimation performance in high CFO scenarios for OFDM systems can be improved.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A wireless receiving system, comprising:
an interface for receiving a received orthogonal frequency division multiplexing (OFDM) signal; and
a processing apparatus for processing the received OFDM signal, comprising:
an estimation module for estimating an auto-correlation matrix relating to the received OFDM signal, the auto-correlation matrix comprising a plurality of elements; and
a calculation module for calculating an amplitude and a phase for each of the elements and calculating a carrier frequency offset (CFO) of the received OFDM signal according to the amplitudes and the phases.

2. The wireless receiving system of claim 1, wherein the received OFDM signal comprises a plurality of samples and the estimation module estimates the auto-correlation matrix according to the samples.

3. The wireless receiving system of claim 2, wherein the processing apparatus further comprises:
a slide module for sliding a sliding window for a first predetermined length;
wherein the sliding window is of a second predetermined length and the extraction module extracts the samples in the sliding window.

4. The wireless receiving system of claim 3, wherein the processing apparatus further comprises:
a decision module for deciding one of a plurality of CFOs as a selected CFO and the second predetermined length corresponding to the selected CFO as a selected timing offset (TO);
wherein the slide module repeatedly slides a sliding window for a first predetermined length, the extraction module repeatedly extracts a plurality of samples from the received OFDM signal, the estimation module repeatedly estimates an auto-correlation matrix of the received OFDM signal, and the calculation module repeatedly calculates an amplitude and a phase for each of the elements and repeatedly calculates a carrier frequency offset (CFO) of the received OFDM signal according to the amplitudes and the phases to derive a plurality of CFOs.

5. The wireless receiving system of claim 4, wherein the processing apparatus further comprises:
an adjustment module for adjusting a signal relating to the received OFDM signal according to the selected CFO and the selected TO.

6. The wireless receiving system of claim 1, wherein the processing apparatus further comprises:
an adjustment module for adjusting a signal relating to the received OFDM signal according to the CFO.

7. An apparatus for processing a received OFDM signal, comprising:
an estimation module for estimating an auto-correlation matrix relating to the received OFDM signal, the auto-correlation matrix comprising a plurality of elements; and
a calculation module for calculating an amplitude and a phase for each of the elements and calculating a CFO of the received OFDM signal according to the amplitudes and the phases.

8. The apparatus of claim 7, wherein the received OFDM signal comprises a plurality of samples and the estimation module estimates the auto-correlation matrix according to the samples.

9. The apparatus of claim 8, further comprising:
a slide module for sliding a sliding window for a first predetermined length;
wherein the sliding window is of a second predetermined length and the extraction module extracts the samples in the sliding window.

10. The apparatus of claim 9, further comprising:
a decision module for deciding one of a plurality of CFOs as a selected CFO and the second predetermined length corresponding to the selected CFO as a selected TO;
wherein the slide module repeatedly slides a sliding window for a first predetermined length, the extraction module repeatedly extracts a plurality of samples from the received OFDM signal, the estimation module repeatedly estimates an auto-correlation matrix of the received OFDM signal, and the calculation module repeatedly calculates an amplitude and a phase for each of the elements and repeatedly calculates a CFO of the received OFDM signal according to the amplitudes and the phases to derive a plurality of CFOs.

11. The apparatus of claim 10, further comprising:
an adjustment module for adjusting a signal relating to the received OFDM signal according to the selected CFO and the selected TO.

12. The apparatus of claim 7, further comprising:
an adjustment module for adjusting a signal relating to the received OFDM signal according to the CFO.

13. A method for processing a received OFDM signal, comprising the steps of:
(a) estimating an auto-correlation matrix relating to the received OFDM signal, the auto-correlation matrix comprising a plurality of elements;
(b) calculating an amplitude and a phase for each of the elements; and
(c) calculating a carrier frequency offset of the received OFDM signal according to the amplitudes and the phases.

14. The method of claim 13, wherein the received OFDM signal comprises a plurality of samples and the step (a) estimates the auto-correlation matrix according to the samples.

15. The method of claim 14, further comprising the step of:
(e) sliding a sliding window for a first predetermined length;
wherein the sliding window is of a second predetermined length and the step (d) extracts the samples in the sliding window.

16. The method of claim 15, further comprising the steps of:
repeating the step (e), step (d), step (a), step (b), and step (c) in sequence to derive a plurality of CFOs; and
deciding one of the CFOs as a selected CFO and the second predetermined length corresponding to the selected CFO as a selected TO.

17. The method of claim 16, further comprising the step of:
adjusting a signal relating to the received OFDM signal according to the selected CFO and the selected TO.

18. The method of claim 13, further comprising the step of:
adjusting a signal relating to the received OFDM signal according to the CFO.
